(19) United States
(12) Patent Application Publication
(10) Pub. No.: US 2012/0026299 A1
(43) Pub. Date: Feb. 2, 2012

(54) VIDEO IMAGE PROCESSING APPARATUS AND VIDEO IMAGE PROCESSING METHOD

(75) Inventor: Takayuki Arai, Tokyo (JP)

(73) Assignee: Kabushiki Kaisha Toshiba, Tokyo (JP)

(21) Appl. No.: 13/095,278

(22) Filed: Apr. 27, 2011

(30) Foreign Application Priority Data
Jul. 27, 2010 (JP) 2010-168554

(51) Int. Cl. H04N 13/02

(52) U.S. Cl. 348/49; 348/E13.074

(57) ABSTRACT

According to one embodiment, a video image processing apparatus includes: an input module to which a frame comprising a first left eye image and a first right eye image is inputted; and a display control module configured to allow a display device to display a second left eye image that includes the inputted first left eye image but excludes at least part of an image located around the first left eye image, and a second right eye image that includes the inputted first right eye image but excludes at least part of an image located around the first right eye image, the second left eye image and the second right eye image being displayed with a resolution corresponding to a screen resolution of the display device.

### CROSS REFERENCE TO RELATED APPLICATION(S)

The application is based upon and claims the benefit of priority from Japanese Patent Application No. 2010-168554 filed on Jul. 27, 2010, the entire contents of which are incorporated herein by reference.

### BACKGROUND

1. Field

Embodiments of the present invention relate to video image processing apparatuses and video image processing methods.

2. Description of the Related Art

There is a technique for a display device for alternately displaying a right eye image and a left eye image, thereby presenting a three-dimensional video image to a user. In the display device according to this technique, a three-dimensional video image may be inputted by using an input format in which both of a right eye image and a left eye image are included in a single frame, for example. Examples of this input format include: a Side-by-Side format in which right eye and left eye images are arranged side by side; and a Top-and-Bottom format in which images are arranged one above the other. Further, the display device separates a right eye image and a left eye image from an inputted frame, converts these right eye and left eye images into images of resolutions each corresponding to a screen resolution of the display device, and then outputs the resulting images to a screen.

Furthermore, there is a technique for displaying, upon input of a two-dimensional video image to a display device, the two-dimensional video image on a display by performing overscanning using a high-resolution processing engine. In this case, the display device cuts out an image of a given size from a frame of the inputted video image, and then enlarges the size of the cutout image to a display size, thus displaying the enlarged image on the display.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1A is a diagram illustrating an example of a use mode of a television apparatus according to a first embodiment;

FIG. 1B is a diagram illustrating exemplary video image processing performed by the television apparatus according to the first embodiment;

FIG. 2 is a diagram illustrating an example of a system configuration of the television apparatus according to the first embodiment;

FIG. 3 is a diagram illustrating an example of a functional block of the television apparatus according to the first embodiment;

FIGS. 4A to 4D are diagrams illustrating examples of processes performed on video image data of a Side-by-Side format in the television apparatus according to the first embodiment;

FIGS. 5A to 5D are diagrams illustrating examples of processes performed on video image data of a Top-and-Bottom format in the television apparatus according to the first embodiment;

FIGS. 6A to 6C are diagrams illustrating examples of processes performed on two-dimensional video image data in the television apparatus according to the first embodiment;

FIG. 7 is a flow chart illustrating an example of a flow of processing performed on video image data in the television apparatus according to the first embodiment;

FIG. 8 is a diagram illustrating an example of a functional block of a television apparatus according to a second embodiment;

FIGS. 9A to 9C are diagrams illustrating examples of processes performed on video image data of a Side-by-Side format in the television apparatus according to the second embodiment;

FIGS. 10A to 10C are diagrams illustrating examples of processes performed on video image data of a Top-and-Bottom format in the television apparatus according to the second embodiment; and

FIG. 11 is a flow chart illustrating an example of a flow of processing performed on video image data in the television apparatus according to the second embodiment.

### DETAILED DESCRIPTION

Hereinafter, a first embodiment of the present invention will be described with reference to the drawings.

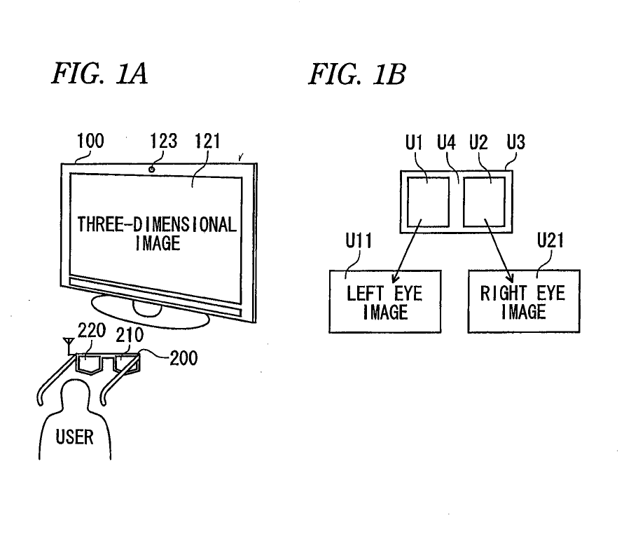

FIG. 1A is a diagram illustrating an example of a use mode of a video image processing apparatus according to the present embodiment. The video image processing apparatus according to the present embodiment is implemented as a television apparatus 100, for example.

The television apparatus 100 includes modules such as a display unit 121 and a control signal transmitter 123, and thus has the function of presenting a two-dimensional video image and a three-dimensional video image to a user.

In this embodiment, the television apparatus 100 alternately displays a right eye image and a left eye image on the display unit 121, and transmits a signal for opening and closing a right eye shutter 210 and a left eye shutter 220 of shutter eyeglasses 200 to the shutter eyeglasses 200 from the control signal transmitter 123, thereby allowing the user who wears the shutter eyeglasses 200 to see a three-dimensional video image.

FIG. 1B is a diagram illustrating exemplary video image processing performed by the television apparatus 100 according to the present embodiment.

A three-dimensional video image frame U3 including a left eye image U1 and a right eye image U2, for example, is inputted to the television apparatus 100. Then, the television apparatus 100 converts the images U1 and U2 into images U11 and U21 of resolutions each corresponding to a resolution of the display unit 121, and displays the images U11 and 021 on the display unit 121.

Actually, in a typical television apparatus for displaying a two-dimensional video image, with the aim of hiding a distortion and/or a noise at an end of a television broadcasting video image, an end portion of the received television broadcasting video image may be prevented from being displayed, and a video image from which this end portion is excluded may be displayed. Hence, in consideration of upper, lower, right and left end portions that might not be displayed on the television apparatus, a television broadcast station broadcasts two-dimensional video image data in which an image is positioned so as not to be located at upper, lower, right and left ends of a frame. Of all regions of a frame, a region where an image should be contained is referred to as a “safety zone”, and a recommended criterion for a safety zone range is determined by organizations such as SMPTE and ARIB.

Further, also when three-dimensional video image data is broadcast, it is conceivable that a region U4 may be provided around the left eye image U1 and the right eye image U2 as illustrated in FIG. 1B, thus making settings so as to prevent the left eye image and right eye image from being located at upper, lower, right and left ends of the frame U3. In that case, the television apparatus 100 is preferably capable of displaying each of the left eye image and right eye image exclusive of the region U4.

Furthermore, even when no region U4 is provided and a left eye image is located all over the left half of the frame U3 while a right eye image is located all over the right half of the frame U3, a user may select a screen display mode, for example, thereby making settings to allow zoom display of a left eye image and a right eye image, included in a frame, on a display in such a manner that a center portion of each of the images is enlarged.

Moreover, in each of these cases, the television apparatus 100 is preferably capable of displaying, on a display screen, a left eye image and a right eye image with a parallax substantially equal to a parallax between a left eye image and a right eye image which are included in a frame.

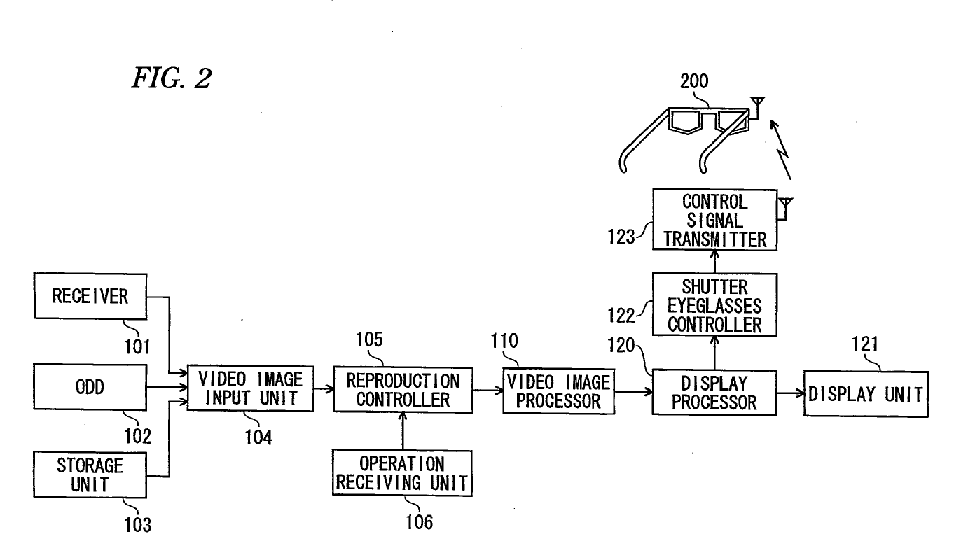

On the other hand, the television apparatus 100 according to the present embodiment is capable of suitably displaying a left eye image and a right eye image included in a three-dimensional video image data frame provided with a peripheral region, but details on this feature will be described later with reference to FIGS. 2 to 11.

Next, referring to FIG. 2, an example of a system configuration of the television apparatus 100 will be described.

The television apparatus 100 includes modules such as: a receiver 101; an ODD 102; a storage unit 103; a video image input unit 104; a reproduction controller 105; an operation receiving unit 106; a video image processor 110; a display processor 120; the display unit 121; a shutter eyeglasses controller 122; and the control signal transmitter 123.

The receiver 101 functions, for example, as a tuner for receiving video image data superimposed on airwaves and/or as a communication unit for receiving video image data of IP TV contents via a network, thus receiving 3D broadcasting provided via services such as CATV and BS digital broadcasting. Further, the received video image data is outputted to the video image input unit 104.

The ODD 102 has the function of reading video image data recorded on an optical disk, and outputs the read video image data to the video image input unit 104. The storage unit 103 is a storage device such as a HDD or a memory, and has the functions of storing the video image data received by the receiver 101 and outputting the stored video image data to the video image input unit 104 in response to an instruction provided from the reproduction controller 105.

The video image input unit 104 is a module to which video image data is inputted from the modules such as the receiver 101, the ODD 102 and the storage unit 103. Alternatively, video image data may be inputted to the video image input unit 104 from an external device of the television apparatus 100. In that case, video image data is inputted to the video image input unit 104 through an interface such as an HDMI, for example.

The reproduction controller 105 performs processing concerning video image reproduction on the television apparatus 100. In accordance with, for example, a user's operational input received by the operation receiving unit 106, the reproduction controller 105 decides which of the modules, including the receiver 101, the ODD 102 and the storage unit 103, should feed video image data to the reproduction controller 105. Then, the reproduction controller 105 is fed video image data from the decided module via the video image input unit 104, and outputs the video image data to the video image processor 110.

Furthermore, the reproduction controller 105 determines a format of the inputted video image data. Specifically, the reproduction controller 105 determines whether the inputted video image data is two-dimensional video image data or three-dimensional video image data, and when the inputted video image data is three-dimensional video image data, the reproduction controller 105 determines which of formats, e.g., a Side-by-Side format, a Top-and-Bottom format and a Frame Packing format, is used. In this case, at the time of input of video image data, the module, which has outputted this video image data, provides notification about the format of this video image data to the reproduction controller 105, and the reproduction controller 105 determines the format based on this notification. Alternatively, the reproduction controller 105 analyzes video image data and/or receives a user's operation, thus determining the format of the inputted video image data.

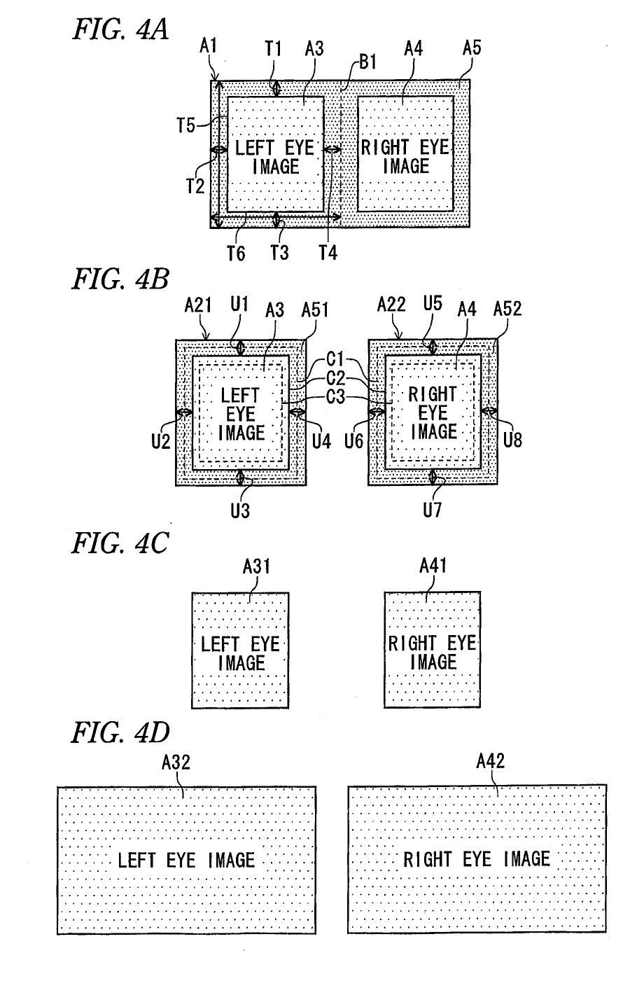

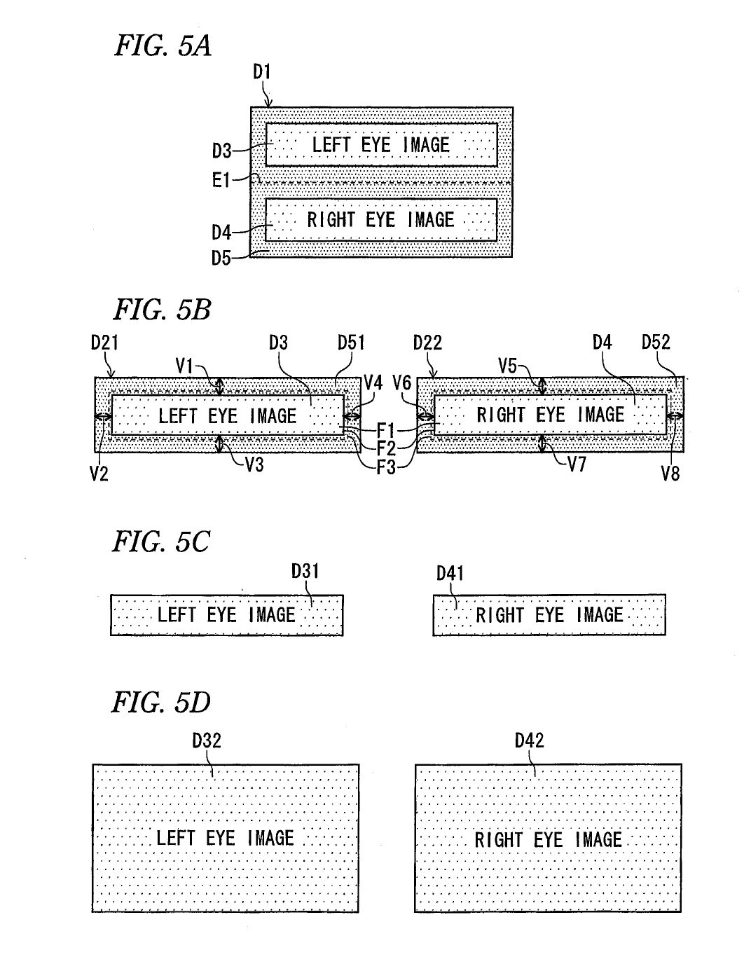

Moreover, the reproduction controller 105 decides a range of an image to be cut out from a frame, i.e., a position and a size (resolution) of an image to be cut out from a frame, and provides, to the video image processor 110, an instruction for cutting out the image in accordance with the decided range. In this embodiment, the reproduction controller 105 may decide cutout position and size by default, for example, or may decide cutout position and size in accordance with notification provided from the operation receiving unit 106. Note that details of the cutout range will be described later with reference to FIGS. 4A to 5D.

The operation receiving unit 106 receives an operational input made by a user. In this embodiment, the operation receiving unit 106 receives: an operational input for deciding from which of the modules, including the receiver 101, the ODD 102 and the storage unit 103, a video image should be fed for reproduction; and/or an operational input for deciding a range of an image displayed on the display unit 121, among those included in a frame of video image data to be reproduced. Note that examples of an operational input for deciding a range of an image to be displayed include: an operation input for deciding whether or not a video image should be overscanned and displayed; and an operational input for deciding how much a video image should be overscanned when it is overscanned.

Further, upon reception of an operational input for deciding from which module a video image should be fed for reproduction, the operation receiving unit 106 provides notification corresponding to this operational input to the reproduction controller 105. Besides, upon reception of an operational input for deciding a range of an image to be displayed among those included in a frame of video image data to be reproduced, the operation receiving unit 106 outputs notification corresponding to this operation to the video image processor 110.

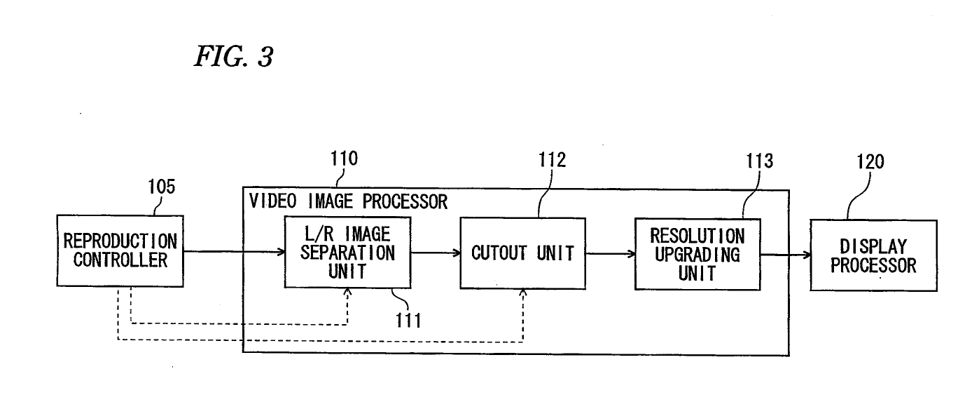

The video image processor 110 performs various video image processes on video image data inputted from the reproduction controller 105. In this embodiment, the video image processor 110 has, for example, the functions of: separating a left eye image and a right eye image included in a frame of three-dimensional video image data; cutting out each of the separated right eye image and left eye image at a given range responsive to an instruction provided from the reproduction controller 105; and enlarging the cutout images in such a manner that the cutout images each conform to a screen size (resolution) of the display unit 121. Note that detailed functions of the video image processor 110 will be described later with reference to FIG. 3.

The display processor 120 has the function of converting video image data, inputted from the video image processor 110, into a signal for display. Further, the display processor 120 outputs this signal to the display unit 121, and the display unit 121 displays a video image based on this signal. Furthermore, when a three-dimensional video image is outputted to the display unit 121, the display processor 120 outputs, to the shutter eyeglasses controller 122, a shutter opening/closing instruction for the shutter eyeglasses 200.

Note that when an image that is being currently outputted is a left eye image, the display processor 120 outputs an instruction for opening a left eye shutter and closing a right eye shutter to the shutter eyeglasses controller 122; on the other hand, when an image that is being outputted is a right eye image, the display processor 120 outputs an instruction for opening the right eye shutter and closing the left eye shutter to the shutter eyeglasses controller 122.

The shutter eyeglasses controller 122 converts the shutter opening/closing instruction, inputted from the display processor 120, into a signal for the shutter eyeglasses, and outputs the resulting signal to the control signal transmitter 123. Moreover, via infrared communication, wireless communication or the like, for example, the control signal transmitter 123 outputs, to the shutter eyeglasses 200, the signal inputted from the shutter eyeglasses controller 122.

Next, referring to FIG. 3, examples of functions of the video image processor 110 will be described. FIG. 3 is a diagram illustrating an example of a functional block of the video image processor 110. In this embodiment, the video image processor 110 includes: an L/R image separation unit 111; a cutout unit 112; and a resolution upgrading unit 113.

The L/R image separation unit 111 receives, from the reproduction controller 105, notification about video image data format or the like. When inputted video image data is three-dimensional video image data, the L/R image separation unit 111 divides an image, included in a frame of the three-dimensional video image data, into two images, i.e., right and left images, thereby separating an image including a right eye image and an image including a left eye image, among those included in this frame.

Then, the L/R image separation unit 111 outputs each of the divided images to the cutout unit 112. In this embodiment, after having divided the image included in the frame, the L/R image separation unit 111 alternately outputs, to the cutout unit 112, image data including a right eye image and image data including a left eye image, for example.

Furthermore, the L/R image separation unit 111 also has the function of converting a frame rate of the inputted three-dimensional video image data. In other words, when a frame including a left eye image and a right eye image is inputted at 60 Hz, for example, images divided from this frame are Outputted to the cutout unit 112 at 120 Hz.

Note that when the inputted video image data is two-dimensional video image data, the L/R image separation unit 111 outputs an image of this video image data to the cutout unit 112 without separating the image.

The cutout unit 112 cuts out, from the inputted image, an image at a given range. Note that in this embodiment, the cutout unit 112 is given an instruction for a cutout range from the reproduction controller 105, and cuts out an image at a range responsive to this instruction. Then, the cutout unit 112 outputs the cutout image to the resolution upgrading unit 113.

The resolution upgrading unit 113 upgrades a resolution of the image inputted from the cutout unit 112. Specifically, the resolution upgrading unit 113 enlarges a size (resolution) of the inputted image to a size conforming to the screen size (resolution) of the display unit 121. Moreover, the resolution upgrading unit 113 not only performs image enlargement but also performs an image quality improving process for improving an image quality. Besides, the resolution upgrading unit 113 outputs, to the display processor 120, image data whose resolution has been upgraded.

Next, referring to FIGS. 4A to 5D, examples of processes performed when three-dimensional video image data is inputted to the video image processor 110 will be described.

First, referring to FIGS. 4A to 4D, examples of processes performed when three-dimensional video image data of a Side-by-Side format is inputted to the video image processor 110 will be described.

In this embodiment, a frame A1 illustrated in FIG. 4A is an example of a frame of a Side-by-Side format, which has been inputted to the L/R image separation unit 111. The frame A1 includes a left eye image A3 and a right eye image A4. Furthermore, an image A5 different from the images A3 and A4 is located around the left eye image A3 and the right eye image A4. In this embodiment, as the left eye image A3 and the right eye image A4, images for moving images of television broadcasting or the like are located.

Moreover, the left eye image A3 and the right eye image A4 are each located at a given distance from an end of the frame A1. Besides, the images A3 and A4 are also each located at a given distance from a center line B1 passing through the center of the frame A1.

In this embodiment, an upper end of the left eye image A3 and that of the frame A1 are located away from each other at a distance T1. Further, a left end of the left eye image A3 and that of the frame A1 are located away from each other at a distance T2, a lower end of the left eye image A3 and that of the frame A1 are located away from each other at a distance T3, and a right end of the left eye image A3 and the center line B1 are located away from each other at a distance T4. Furthermore, a length of each of the distances T1 and T3 corresponds to a length of a given part of a distance T5 between the upper and lower ends of the frame A1, for example, and similarly, a length of each of the distances T2 and T4 corresponds to a given part of a length of a distance T6 between the left end of the frame A1 and the center line B1. Alternatively, the lengths of the distances T1 to T4 may each be a length of a given number of pixels, for example.

Note that although the location of the left eye image A3 has been described above, the right eye image A4 is located similarly to the left eye image A3. Specifically, the right eye image A9 is located at a distance from the end of the frame A1 for a given number of pixels, or located at a distance corresponding to a given part of the length of the frame A1 from the end of the frame A1.

In this embodiment, upon input of the frame A1 of video image data, the L/R image separation unit 111 divides this frame A1 along the center line B1, thus separating an image including a left eye image and an image including a right eye image from each other.

Images A21 and A22 illustrated in FIG. 4B each serve as an example of an image separated by the L/R image separation unit 111. In this embodiment, the image A21 includes the left eye image A3, and the image A22 includes the right eye image A4. Moreover, an image A51 is located around the left eye image A3, and an image A52 is located around the right eye image A4. Besides, the images A21 and A22 are inputted to the cutout unit 112.

The cutout unit 112 cuts out each of the left eye image and right eye image from the images A21 and A22 at a range based on an instruction provided from the reproduction controller 105. Note that in this embodiment, the range refers to a position and a size (resolution), for example. Specifically, when the cutout unit 112 receives, from the reproduction controller 105, for example, an instruction for allowing an image cutout size to conform to a size of each of the left eye image A3 and the right eye image A4 serving as the original images included in the frame inputted to the cutout unit 112, the cutout unit 112 cuts out each of the left eye image and right eye image with a size C2 substantially equal to a size (resolution) of each of the left eye image A3 and the right eye image A4.

Moreover, in this embodiment, when the cutout unit 112 cuts out each of the left eye image and right eye image with the size C2, the cutout unit 112 cuts out the left eye image and right eye image at positions that allow a parallax between the left eye image A3 and the right eye image A4 included in the inputted frame to be maintained. Specifically, suppose that a distance between an upper end of the size C2 and that of the image A21 is defined as U1, a distance between a left end of the size C2 and that of the image A21 is defined as U2, a distance between a lower end of the size C2 and that of the image A21 is defined as U3, a distance between a right end of the size C2 and that of the image A21 is defined as U4, a distance between the upper end of the size C2 and that of the image A22 is defined as U5, a distance between the left end of the size C2 and that of the image A22 is defined as U6, a distance between the lower end of the size C2 and that of the image A22 is defined as U7, and a distance between the right end of the size C2 and that of the image A22 is defined as U8. Then, the cutout unit 112 cuts out the images so that lengths of the distances U1 and U5 are equal to each other, lengths of the distances U2 and 06 are equal to each other, lengths of the distances U3 and U7 are equal to each other, and lengths of the distances U4 and 08 are equal to each other.

Further, when the cutout unit 112 receives an instruction for allowing an image cutout size to be larger than the size of each of the left eye image A3 and the right eye image A4, the cutout unit 112 cuts out each of the left eye image and right eye image with a size C1. Furthermore, when the cutout unit 112 receives an instruction for allowing an image cutout size to be smaller than the size of each of the left eye image A3 and the right eye image A4, i.e., when the cutout unit 112 receives an instruction for partially enlarging the inputted images and allowing zoom display thereof on a display screen, the cutout unit 112 cuts out each of the left eye image and right eye image with a size C3. Note that similarly to the size C2, the sizes C1 and C3 are positions and sizes which allow a parallax between the cutout images to be maintained at a parallax between the original images.

Note that FIG. 4C is a diagram illustrating a left eye image A31 and a right eye image A41 which have been cut out from the images A21 and A22, respectively, along lines of the size C2.

Furthermore, after having cut out the left eye image A31 and the right eye image A41 from the images A21 and A22, respectively, the cutout unit 112 outputs the cutout images to the resolution upgrading unit 113. Then, the resolution upgrading unit 113 upgrades resolutions of these images so that sizes (resolutions) of the inputted left eye image A31 and the right eye image A41 conform to the screen size (screen resolution) of the display unit 121, thus generating a left eye image A32 and a right eye image A42 illustrated in FIG. 4D.

In the examples of the processes illustrated in FIGS. 4A to 4D, the television apparatus 100 is capable of displaying, on a display device, the left eye image A32 exclusive of at least part of the image A5 located around the inputted left eye image A3, and the right eye image A42 exclusive of at least part of the image A5 located around the inputted right eye image A4, with the sizes of the left eye image A32 and the right eye image A42 conforming to the size (resolution) of the display screen of the display device.

Further, at a position corresponding to a position where one of the right eye image and left eye image is cut out, the cutout unit 112 cuts out the other one of the right eye image and left eye image, thus making it possible to prevent a parallax between the cutout right eye image and left eye image from being deviated from a parallax between the images that are not yet cut out.

Note that referring to FIGS. 4A to 4D, the description has been made assuming that the examples of the processes are performed when the left eye image A3 and the right eye image A4 are each placed in a region located away from an end portion of the frame A1, but the examples of the processes are also applicable to a case where a left eye image is located all over the left half of a frame and a right eye image is located all over the right half of the frame. Specifically, an image that excludes an end portion of a left eye image included in a frame, and an image that excludes an end portion of a right eye image may be cut out so that cutout positions and sizes thereof conform to each other, and the cutout images may each be displayed on the display unit 121 with a resolution corresponding to the resolution of the display screen.

Subsequently, referring to FIGS. 5A to 5D, examples of processes performed when three-dimensional video image data of a Top-and-Bottom format is inputted to the video image processor 110 will be described.

A frame D1 illustrated in FIG. 5A is an example of a frame of a Top-and-Bottom format, which has been inputted to the L/R image separation unit 111. In this embodiment, the frame D1 includes a left eye image D3 and a right eye image D4. Furthermore, an image D5 exists around the left eye image D3 and the right eye image D4. Note that similarly to the case of a Side-by-Side format described above with reference to FIGS. 4A to 4D, the left eye image D3 and the right eye image D4 are each located at a given distance from an end of the frame D1 and a center line E1 passing through the center of the frame D1.

In this embodiment, the distances of the left eye image D3 and the right eye image D4 from the end of the frame D1 and the center line E1 each correspond to a given part of a longitudinal/lateral length of the frame D1, for example. Alternatively, the distances of the images D3 and D4 from the end of the frame D1 and the center line E1 may each correspond to a given number of pixels, for example.

FIG. 5B is a diagram illustrating images D21 and d22 divided by the L/R image separation unit 111. Note that the image D21 includes the left eye image D3, and the image D22 includes the right eye image D4. Moreover, an image D51 is located around the left eye image D3, and an image D52 is located around the right eye image D4. Besides, the images D21 and D22 are inputted to the cutout unit 112.

In this embodiment, the cutout unit 112 cuts out each of the left eye image and right eye image from the images D21 and D22 at a position and a size (resolution) which are based on an instruction provided from the reproduction controller 105. Specifically, when the cutout unit 112 receives, from the reproduction controller 105, an instruction for allowing an image cutout size to be larger than a size of each of the left eye image D3 and the right eye image D4, the cutout unit 112 cuts out each of the left eye image and right eye image with a size F3. When the cutout unit 112 receives, from the reproduction controller 105, an instruction for allowing an image cutout size to conform to the size of each of the left eye image D3 and the right eye image D4, the cutout unit 112 cuts out each of the left eye image and right eye image with a size F2. And when the cutout unit 112 receives, from the reproduction controller 105, an instruction for allowing an image cutout size to be smaller than the size of each of the left eye image D3 and the right eye image D4, i.e., when the cutout unit 112 receives an instruction for partially enlarging the inputted images and allowing zoom display thereof on the display screen, the cutout unit 112 cuts out each of the left eye image and right eye image with a size F1.

Note that as also described with reference to FIGS. 4A to 4D, the cutout unit 112 cuts out the left eye image and right eye image at positions and sizes which allow a parallax between the cutout images to be maintained at a parallax between the original images inputted to the cutout unit 112. Specifically, when the images are each cut out with the size F2, for example, suppose that a distance between an upper end of the size F2 and that of the image D21 is defined as V1, a distance between a left end of the size F2 and that of the image D21 is defined as V2, a distance between a lower end of the size F2 and that of the image D21 is defined as V3, a distance between a right end of the size F2 and that of the image D21 is defined as V4, a distance between the upper end of the size F2 and that of the image D22 is defined as V5, a distance between the left end of the size F2 and that of the image D22 is defined as V6, a distance between the lower end of the size F2 and that of the image D22 is defined as V7, and a distance between the right end of the size F2 and that of the image D22 is defined as V8. Then, the left eye image and right eye image are cut out so that lengths of the distances V1 and V5 are equal to each other, lengths of the distances V2 and V6 are equal to each other, lengths of the distances V3 and V7 are equal to each other, and lengths of the distances V4 and V8 are equal to each other.

FIG. 5C is a diagram illustrating a left eye image D31 and a right eye image D41 cut out from the images D21 and D22, respectively, along lines of the size F2. After having cut out the left eye image D31 and the right eye image D41 from the images D21 and D22, respectively, the cutout unit 112 outputs the cutout images to the resolution upgrading unit 113. Then, the resolution upgrading unit 113 upgrades resolutions of these images so that sizes (resolutions) of the inputted left eye image D31 and right eye image D41 conform to the screen size (screen resolution) of the display unit 121, and outputs the resulting images to the display processor 120.

In the examples of the processes illustrated in FIGS. 4A to 4D and FIGS. 5A to 5D, the television apparatus 100 according to the present embodiment is capable of dividing a frame into a left part image and a right part image, and then cutting out each of the left eye image A31 (D31) and the right eye image A41 (D41) at a given range, thereby allowing the cutout images to be displayed with sizes conforming to the size of the display screen. As a result, the television apparatus 100 is capable of performing overscanning on images of three-dimensional video image data and performing zoom display thereof.

Moreover, when a left eye image and a right eye image are displayed on the display unit 121, the television apparatus 100 according to the present embodiment is capable of cutting out the left eye image and right eye image so that the positional relationship between theses images is adaptive and a parallax between the right eye image and left eye image included in a frame of original video image data is maintained. Hence, the television apparatus 100 is capable of performing overscanning without changing the parallax between the left eye image and right eye image.

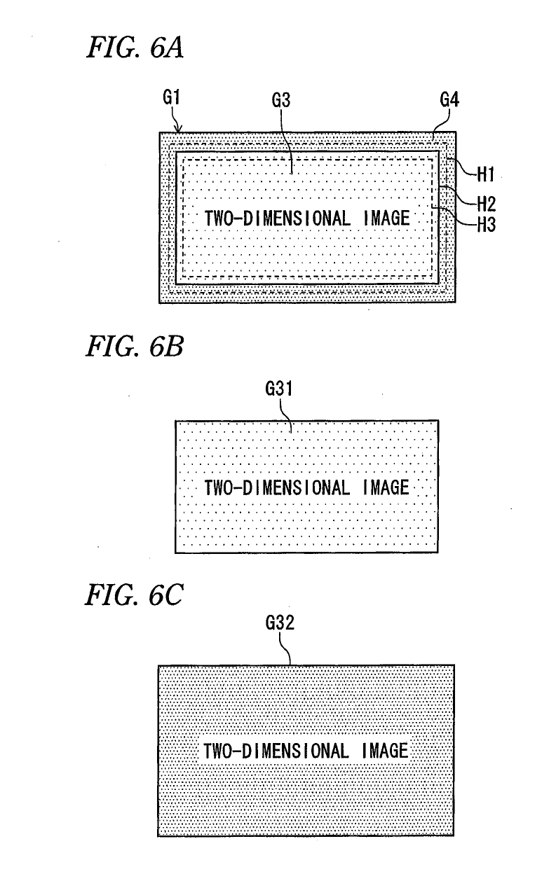

Next, referring to FIGS. 6A to 6C, examples of processes performed by the video image processor 110 when two-dimensional video image data is inputted thereto will be described.

A frame G1 illustrated in FIG. 6A is an example of a frame of two-dimensional video image data, which has been inputted to the L/R image separation unit 111. In this embodiment, the frame G1 includes a two-dimensional image G3. Further, an image G4 is located around the image G3. Furthermore, the image G3 is located at a distance of a given part of a longitudinal/lateral length of the frame G1, for example, from an end of the frame G1. Alternatively, the image G3 may be located at a distance of a given number of pixels, for example, from the end of the frame G1. Moreover, the frame G1 is outputted to the cutout unit 112.

In this embodiment, the cutout unit 112 cuts out the two-dimensional image from the frame G1 at a position and a size (resolution) which are based on an instruction provided from the reproduction controller 105. Specifically, when the cutout unit 112 receives, from the reproduction controller 105, an instruction for allowing an image cutout size to be larger than a size of the two-dimensional image G3 serving as the original image included in the frame G1 inputted to the cutout unit 112, the cutout unit 112 cuts out the two-dimensional image with a size H1. When the cutout unit 112 receives, from the reproduction controller 105, an instruction for allowing an image cutout size to conform to the size of the two-dimensional image G3, the cutout unit 112 cuts out the two-dimensional image with a size H2. And when the cutout unit 112 receives, from the reproduction controller 105, an instruction for partially enlarging the inputted image and allowing zoom display thereof on the display screen, the cutout unit 112 cuts out the two-dimensional image with a size H3. Note that FIG. 6B is a diagram illustrating a two-dimensional image G31 cut out from the frame G1 along lines of the size H2.

Furthermore, after having cut out the two-dimensional image G31 from the frame G1, the cutout unit 112 outputs the cutout image to the resolution upgrading unit 113. Then, the resolution upgrading unit 113 upgrades a resolution of this image so that the size (resolution) of the two-dimensional image G31 conforms to the screen size (screen resolution) of the display unit 121, thereby generating a two-dimensional image G32 illustrated in FIG. 6C.

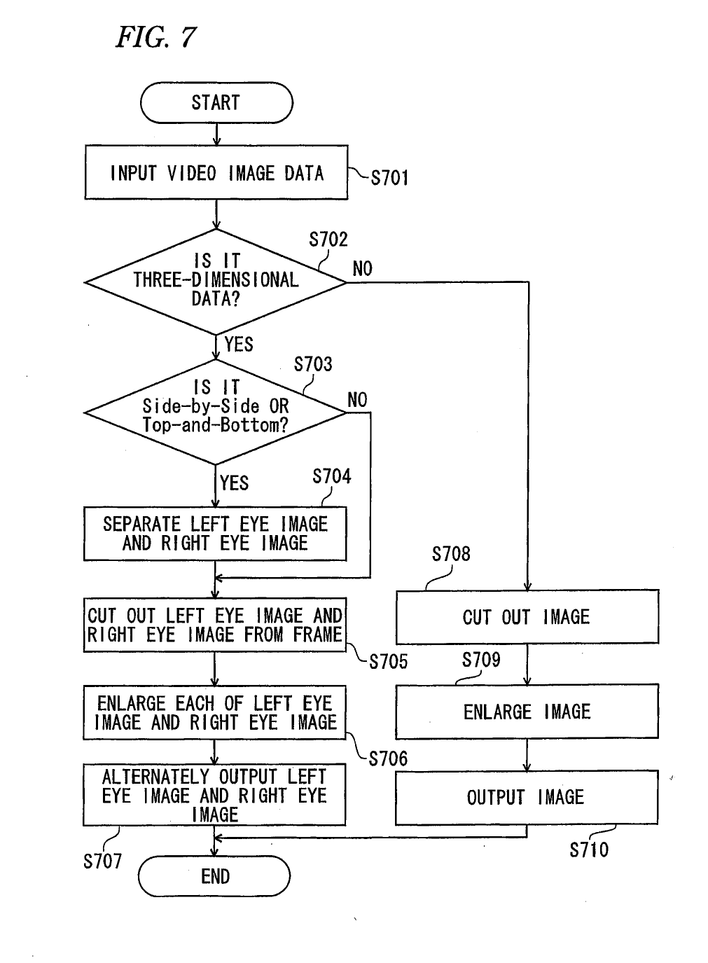

Next, referring to FIG. 7, an example of a flow of processing concerning display of two-dimensional or three-dimensional image(s) on the television apparatus 100 will be described.

First, video image data is inputted to the reproduction controller 105 (S701). Then, the reproduction controller 105 determines a format of this video image data, and outputs notification indicative of a determination result to the L/R image separation unit 111 (S702).

Upon reception of notification that the video image data is three-dimensional video image data (Yes in S702) and upon determination that the format of the video image data is a Side-by-Side format or a Top-and-Bottom format (Yes in S703), the L/R image separation unit 111 divides an image included in the inputted frame, thereby separating a left eye image and a right eye image (S704). Then, each of the divided images is outputted to the cutout unit 112. On the other hand, upon determination in S703 that the format of the video image data is neither a Side-by-Side format nor a Top-and-Bottom format (No in 5703), e.g., upon determination that the video image data is a three-dimensional video image of a Frame Packing format, the L/R image separation unit 111 outputs an image of the inputted frame to the cutout unit 112 without dividing the image.

Upon input of the image(s), the cutout unit 112 cuts out, from the inputted image (s), each of a left eye image and a right eye image with a size (resolution) and a position which are based on an instruction provided from the reproduction controller 105 (S705), and outputs each of the cutout left eye image and right eye image to the resolution upgrading unit 113. Note that when an instruction for performing no overscanning on the inputted image(s) is received from the reproduction controller 105, the cutout unit 112 may output the image(s) to the resolution upgrading unit 113 without cutting out a left eye image and a right eye image.

Then, the resolution upgrading unit 113 enlarges the inputted image(s) to upgrade resolution(s) thereof (S706), and outputs the resulting image (s) to the display processor 120 (S707). Note that when video image data of a Frame Packing format, for example, is inputted in this embodiment, the resolution upgrading unit 113 may output the inputted images to the display processor 120 without enlarging the inputted images.

Further, in that case, the resolution upgrading unit 113 alternately outputs the left eye image and right eye image to the display processor 120, and the display processor 120 outputs video image signals of these images to the display unit 121. Then, the display unit 121 displays a video image based on the video image signals for the left eye image and right eye image which are alternately inputted, thereby displaying a three-dimensional video image.

On the other hand, upon reception of notification that the video image data is two-dimensional video image data in S702 (No in 5702), the L/R image separation unit 111 outputs the frame of this video image data to the cutout unit 112 without separating any image from the frame. Then, the cutout unit 112 cuts out a two-dimensional image from the frame (S708), and outputs the cutout image to the resolution upgrading unit 113.

The resolution upgrading unit 113 enlarges the size (resolution) of the inputted image so that the size of the inputted image conforms to the screen size of the display unit 121 (S709), and outputs the enlarged image to the display processor 120 (S710). Then, the display processor 120 generates a video image signal of the inputted image to output the generated signal to the display unit 121, and the display unit 121 displays a two-dimensional video image based on the inputted video image signal.

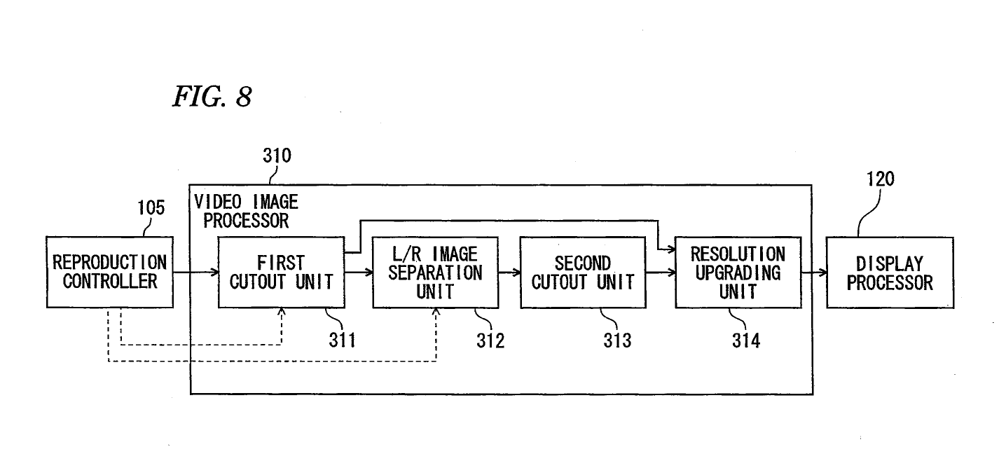

Next, referring to FIGS. 8 to 11, a second embodiment of the present invention will be described. A video image processing apparatus according to the second embodiment is implemented as a television apparatus 300 (not illustrated) including a video image processor 310. Note that the television apparatus 300 according to the second embodiment has a configuration similar to that of the television apparatus 100 according to the first embodiment, and therefore, the following description will be focused on functions of performing operations different from those of the first embodiment.

FIG. 8 is a diagram illustrating an example of a functional block of the video image processor 310 included in the television apparatus 300 according to the second embodiment.

The video image processor 310 includes modules such as: a first cutout unit 311; an L/R image separation unit 312; a second cutout unit 313; and a resolution upgrading unit 314.

The reproduction controller 105 decides a range of an image to be cut out from a frame, i.e., a position and a size (resolution) of an image to be cut out from a frame, and provides, to the first and second cutout units 311 and 313, an instruction for cutting out an image in accordance with the decided range. In this embodiment, the reproduction controller 105 may decide cutout position and size by default, for example, or may decide cutout position and size in accordance with notification provided from the operation receiving unit 106.

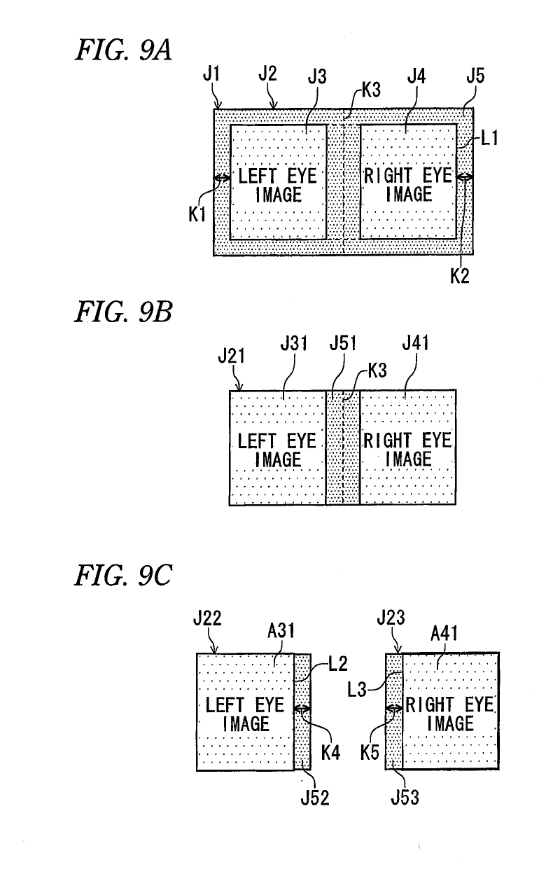

Further, when three-dimensional video image data is inputted to the first cutout unit 311, the reproduction controller 105 provides, to the second cutout unit 313, an instruction for cutout position and size conforming to a position and a size (resolution) of the image cut out by the first cutout unit 311. Note that details of the cutout range will be described later with reference to FIGS. 9A to 100.

The first cutout unit 311 has the function of cutting out image (s) from a frame of video image data inputted from the reproduction controller 105. In this embodiment, when a frame of two-dimensional video image data is inputted to the first cutout unit 311, the first cutout unit 311 performs a process similar to that described with reference to FIGS. 6A and 6C and performed by the cutout unit 112. On the other hand, when a frame of three-dimensional video image data is inputted, the first cutout unit 311 performs a cutout process different from that described with reference to FIGS. 6A to 6C and performed by the cutout unit 112, but this process will be described later with reference to FIGS. 9A to 100.

Further, together with a frame of video image data, notification indicating that this video image data is two-dimensional video image data or three-dimensional video image data is inputted to the first cutout unit 311 from the reproduction controller 105. Then, when three-dimensional video image data is inputted, the first cutout unit 311 outputs the cutout images to the L/R image separation unit 312. On the other hand, when two-dimensional video image data is inputted, the first cutout unit 311 outputs the cutout image to the resolution upgrading unit 314.

The L/R image separation unit 312 divides an image included in the inputted video image data frame into two images, thereby separating a right eye image and a left eye image which are included in the image of the inputted frame. Then, the L/R image separation unit 312 outputs each of the divided images to the second cutout unit 313. Note that in this embodiment, after having dividing the image of the inputted frame, the L/R image separation unit 312 alternately outputs an image including a right eye image and an image including a left eye image, for example, to the second cutout unit 313.

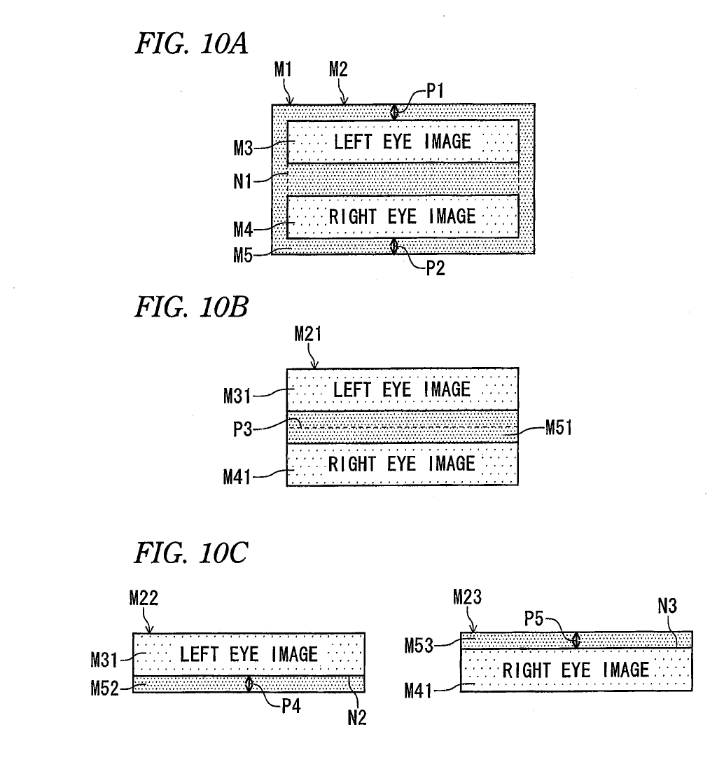

The second cutout unit 313 has the function of cutting out the left eye image and right eye image from the image including the left eye image and the image including the right eye image, respectively. In this embodiment, the second cutout unit 313 cuts out each of the left eye image and right eye image at a range based on an instruction provided from the reproduction controller 105. Note that details of the process performed by the second cutout unit 313 will be described later with reference to FIGS. 9A to 10C. Then, the second cutout unit 313 outputs the cutout left eye image and right eye image to the resolution upgrading unit 314.

The resolution upgrading unit 314 upgrades a resolution of each image inputted from the first cutout unit 311 or the second cutout unit 313. In this embodiment, the resolution upgrading unit 314 enlarges a size (resolution) of the inputted image to a size conforming to the screen size (resolution) of the display unit 121. Then, the resolution upgrading unit 314 outputs, to the display processor 120, the image whose resolution has been upgraded.

Next, referring to FIGS. 9A to 10C, examples of processes performed by the first cutout unit 311, the L/R image separation unit 312 and the second cutout unit 313 when three-dimensional video image data is inputted will be described.

FIGS. 9A to 9C are diagrams illustrating examples of processes performed by the first cutout unit 311, the L/R image separation unit 312 and the second cutout unit 313 when a frame of a Side-by-Side format is inputted to the first cutout unit 311.

A frame J1 illustrated in FIG. 9A is an example of a frame of a Side-by-Side format, which is inputted to the first cutout unit 311. Upon input of the frame J1 for an image J2 including a left eye image J3, a right eye image J4 and an image J5, the first cutout unit 311 cuts out an image including a left eye image and a right eye image from the image J2 of the frame J1 at a range based on an instruction provided from the reproduction controller 105. Note that in this embodiment, the range refers to a position and a size (resolution), for example.

In this embodiment, when the first cutout unit 311 receives, from the reproduction controller 105, for example, an instruction for allowing an image cutout size (resolution) to conform to a size of the left eye image J3 and right eye image J4 serving as the original images included in the frame inputted to the first cutout unit 311, the first cutout unit 311 cuts out an image including the left eye image and right eye image along a cutout line L1. Note that the first cutout unit 311 may cut out an image with a size (resolution) larger than or smaller than a size of the cutout line L1 in accordance with an instruction provided from the reproduction controller 105. Then, the image cut out by the first cutout unit 311 is outputted to the L/R image separation unit 312.

An image J21 illustrated in FIG. 9B is an example of the image cut out by the first cutout unit 311 and outputted to the L/R image separation unit 312. In this embodiment, the image J21 includes a left eye image J31, a right eye image J41 and an image J51. In this embodiment, the L/R image separation unit 312 separates the image J21 into images along a center line K3 passing through the center of the image J21. Then, the L/R image separation unit 312 outputs each of the separated images to the second cutout unit 313.

Images J22 and J23 illustrated in FIG. 9C each serve as an example of the image separated by the L/R image separation unit 312. The image J22 includes the left eye image J31 and an image J52, and the image J23 includes the right eye image J41 and an image J53. Furthermore, the second cutout unit 313 cuts out the left eye image J31 and the right eye image J41 from the images J22 and J23, respectively.

In this embodiment, the second cutout unit 313 cuts out the left eye image and right eye image from the images J22 and J23, respectively, with sizes (resolutions) and positions based on an instruction provided from the reproduction controller 105. When the second cutout unit 313 receives, from the reproduction controller 105, for example, an instruction for allowing an image display size to conform to the screen size, the second cutout unit 313 cuts out the left eye image along a cutout line L2 and cuts out the right eye image along a cutout line L3.

In this case, based on the instruction provided from the reproduction controller 105, the second cutout unit 313 cuts out the images so that a parallax between the cutout left eye image and right eye image is equal to a parallax between the original images of these left eye image and right eye image. Specifically, when the second cutout unit 313 cuts out the images along the cutout lines L2 and L3, a distance K1 between a left end of the frame J1 and the left-end cutout line L1 and a distance K4 between the center line K3 and the right-end cutout line L2 are preferably equal to each other, and furthermore, a distance K2 between a right end of the frame J1 and the right-end cutout line L1 and a distance K5 between the center line K3 and the left-end cutout line L3 are preferably equal to each other.

In accordance with an instruction provided from the reproduction controller 105, the second cutout unit 313 may cut out the images with sizes (resolutions) smaller than those of the cutout lines L2 and L3.

In the examples of the processes illustrated in FIGS. 9A to 9C, the second cutout unit 313 cuts out the left eye image J31 from the image J22 in an area where the image J21 has been cut out by the first cutout unit 311, i.e., at a position corresponding to a length of the distance K2 between a right end of the image J21 and that of the frame J1. In addition, the second cutout unit 313 cuts out the right eye image J41 from the image J23 in an area where the image J21 has been cut out by the first cutout unit 311, i.e., at a position corresponding to a length of the distance K1 between a left end of the image J21 and that of the frame J1. As a result, the television apparatus 300 is capable of preventing the parallax between the right eye image and left eye image cut out by the second cutout unit 313 from being deviated from the parallax between the images that are not yet cut out by the first cutout unit 311.

Subsequently, referring to FIGS. 10A to 10C, examples of processes performed by the first cutout unit 311, the L/R image separation unit 312 and the second cutout unit 313 when a frame of a Top-and-Bottom format is inputted to the first cutout unit 311 will be described.

A frame M1 illustrated in FIG. 10A is an example of a frame of a Top-and-Bottom format, which is inputted to the first cutout unit 311. Upon input of the frame M1 including a left eye image M3, a right eye image M4 and an image M5, the first cutout unit 311 cuts out an image including a left eye image and a right eye image from the frame M1 with a size (resolution) and a position based on an instruction provided from the reproduction controller 105.

In this embodiment, when the first cutout unit 311 receives, from the reproduction controller 105, for example, an instruction for allowing an image cutout size to conform to a size of the left eye image M3 and right eye image M4 serving as the original images included in the frame inputted to the first cutout unit 311, the first cutout unit 311 cuts out an image including a left eye image and a right eye image along a cutout line N1. Note that the first cutout unit 311 may cut out an image with a size (resolution) larger than or smaller than a size of the cutout line N1 in accordance with an instruction provided from the reproduction controller 105. Then, the image cut out by the first cutout unit 311 is outputted to the L/R image separation unit 312.

An image M21 illustrated in FIG. 10B is an example of the image cut out by the first cutout unit 311 and outputted to the L/R image separation unit 312. In this embodiment, the image M21 includes a left eye image M31, a right eye image M41 and an image M51. In this embodiment, the L/R image separation unit 312 separates the image M21 into images along a center line P3 passing through the center of the image M21. Then, the L/R image separation unit 312 outputs each of the separated images to the second cutout unit 313.

Images M22 and M23 illustrated in FIG. 100 each serve as an example of the image separated by the L/R image separation unit 312. In this embodiment, the image M22 includes the left eye image M31 and an image M52, and the image M23 includes the right eye image M41 and an image M53. Furthermore, the second cutout unit 313 cuts out the left eye image M31 and the right eye image M41 from the images M22 and M23, respectively.

In this embodiment, the second cutout unit 313 cuts out the left eye image and right eye image from the images M22 and M23, respectively, with sizes (resolutions) and positions based on an instruction provided from the reproduction controller 105. When the second cutout unit 313 receives, from the reproduction controller 105, for example, an instruction for allowing an image cutout size to conform to a size of the left eye image M3 and right eye image M4 serving as the original images included in the frame inputted to the first cutout unit 311, the second cutout unit 313 cuts out the left eye image along a cutout line N2 and cuts out the right eye image along a cutout line N3.

Note that the second cutout unit 313 may cut out the images with sizes (resolutions) smaller than those of the cutout lines N2 and N3 in accordance with an instruction provided from the reproduction controller 105. However, in this embodiment, the second cutout unit 313 preferably cuts out the images so that a distance P1 between an upper end of the frame M1 and the upper-end cutout line N1 and a distance P4 between the center line P3 and the lower-end cutout line N2 are equal to each other, and a distance P2 between a lower end of the frame M1 and the lower-end cutout line N1 and a distance P5 between the center line P3 and the upper-end cutout line N3 are equal to each other.

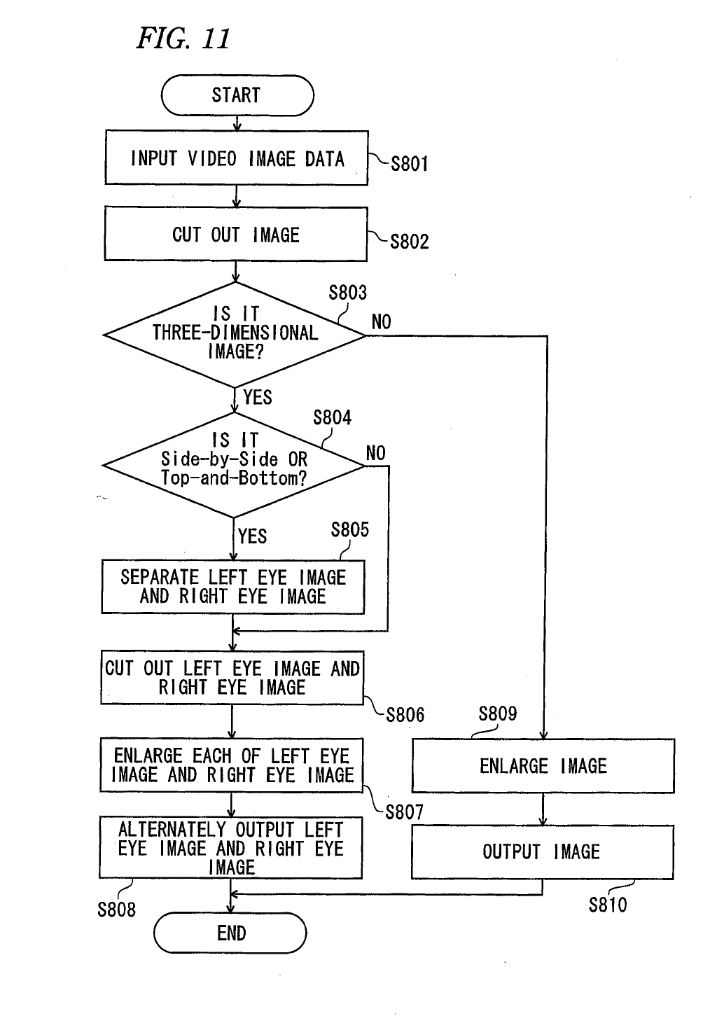

Next, referring to FIG. 11, an example of a flow of processing concerning display of two-dimensional or three-dimensional image(s) on the television apparatus 300 according to the second embodiment will be described.

First, upon input of video image data to the reproduction controller 105 (S801), the reproduction controller 105 outputs the inputted video image data to the first cutout unit 311. Further, in this case, the reproduction controller 105 determines whether or not the inputted video image data is three-dimensional video image data, and outputs a determination result to the first cutout unit 311.

Upon input of the video image data, the first cutout unit 311 cuts out an image from a frame of the inputted video image data (S802).

Furthermore, in this step, the first cutout unit 311 receives, from the reproduction controller 105, notification about a format of the video image data inputted from the reproduction controller 105. Then, upon determination that the frame from which the image is cut out is a three-dimensional video image frame (Yes in S803) and that the format of the video image data is a Side-by-Side format or a Top-and-Bottom format (Yes in S804), the first cutout unit 311 outputs the cutout image to the L/R image separation unit 312.

Subsequently, the L/R image separation unit 111 separates, from the image included in the inputted frame, a left eye image and a right eye image (S805). Then, each of the separated images is outputted to the second cutout unit 313.

On the other hand, upon determination in S804 that the format of the video image data is neither a Side-by-Side format nor a Top-and-Bottom format (No in S804), e.g., upon determination that the video image data is a three-dimensional video image of a Frame Packing format, the first cutout unit 311 outputs the cutout image to the second cutout unit 313.

Upon input of the image (s), the second cutout unit 313 cuts out, from the inputted image (s), each of a left eye image and a right eye image with a size (resolution) and a position which are responsive to an instruction provided from the reproduction controller 105 (S806).

Then, each of the cutout left eye image and right eye image is outputted to the resolution upgrading unit 314. The resolution upgrading unit 314 enlarges these images to upgrade resolutions thereof (S807), and outputs the resulting images to the display processor 120 (S808). Note that in this embodiment, the resolution upgrading unit 314 alternately outputs the left eye image and right eye image to the display processor 120, and the display processor 120 outputs video image signals of these images to the display unit 121. Then, the display unit 121 displays a video image based on the video image signals for the left eye image and right eye image which are alternately inputted, thereby displaying a three-dimensional video image.

On the other hand, upon determination in S803 that the frame from which the image is cut out is a two-dimensional video image frame (No in S803), the first cutout unit 311 outputs the cutout image to the resolution upgrading unit 314. Then, the resolution upgrading unit 314 enlarges the size (resolution) of the inputted image so that the size of the inputted image conforms to the screen size of the display unit 121 (S809), and outputs the enlarged image to the display processor 120 (S810). Then, the display processor 120 generates a video image signal of the inputted image to output the generated signal to the display unit 121, and the display unit 121 displays a two-dimensional video image based on the inputted video image signal.

According to each of the first and second embodiments, the television apparatus is capable of presenting a suitably-sized video image to a user. Moreover, when a left eye image and a right eye image included in a frame are cut out and displayed, the television apparatus is capable of displaying the cutout left eye image and right eye image without changing a parallax between the left eye image and right eye image which are not yet cut out.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video image processing apparatus comprising:
an input module to which a frame comprising a first left eye image and a first right eye image is inputted; and
a display control module configured to allow a display device to display a second left eye image that includes the inputted first left eye image but excludes at least part of an image located around the first left eye image, and a second right eye image that includes the inputted first right eye image but excludes at least part of an image located around the first right eye image, the second left eye image and the second right eye image being displayed with a resolution corresponding to a screen resolution of the display device.

2. The video image processing apparatus according to claim 1, wherein
the display control module comprises:
a separation module configured to separate the first left eye image and the first right eye image inputted to the input module;
a first cutout module configured to cut out the second left eye image from the image comprising the separated first left eye image, and configured to cut out the second right eye image from the image comprising the separated first right eye image, the second right eye image being cut out at a position corresponding to a position where the second left eye image is cut out; and
a resolution upgrading module configured to upgrade a resolution of each of the cutout second left eye image and second right eye image to a resolution corresponding to the screen resolution of the display device.

3. The video image processing apparatus according to claim 1, wherein:
the display control means comprises:
a separation module configured to separate a first image comprising the first left eye image and a second image comprising the first right eye image from the frame inputted to the input means;
a cutout module configured to cut out the second left eye image from the separated first image, and configured to cut out the second right eye image from the separated second image; and
a resolution upgrading module configured to upgrade a resolution of each of the cutout second left eye image and second right eye image to a resolution corresponding to that of a display screen of the display device; and
the cutout module cuts out one of the second right eye image and the second left eye image at a position corresponding to a position where the other one of the second right eye image and the second left eye image is cut out.

4. The video image processing apparatus according to claim 1, wherein
the display control means comprises:
a first cutout unit configured to cut out a first image comprising the first left eye image and the first right eye image from the frame inputted to the input module;
a separation module configured to separate the cutout first image into a second image comprising the first left eye image and a third image comprising the first right eye image;
a second cutout module configured to cut out the second left eye image from the separated second image at a position corresponding to a position where the first image is cut out by the first cutout means, and configured to cut out the second right eye image from the separated third image at a position corresponding to a position where the first image is cut out by the first cutout means; and
a resolution upgrading module configured to upgrade a resolution of each of the cutout second left eye image and second right eye image to a resolution corresponding to that of a display screen of the display device.

5. The video image processing apparatus according to claim 1, wherein:
a length between a left end of the second left eye image and a left end of the frame is equal to a length between a left end of the second right eye image and a center of the frame; and
a length between a right end of the second left eye image and the center of the frame is equal to a length between a right end of the second right eye image and a right end of the frame.

6. The video image processing apparatus according to claim 1, wherein:
a length between an upper end of the second left eye image and an upper end of the frame is equal to a length between an upper end of the second right eye image and a center of the frame; and
a length between a lower end of the second left eye image and the center of the frame is equal to a length between a lower end of the second right eye image and a lower end of the frame.

7. The video image processing apparatus according to claim 2, further comprising receiving means for receiving an operational input,
wherein the first cutout means cuts out the second left eye image and the second right eye image with resolutions responsive to the operational input.

8. The video image processing apparatus according to claim 1, further comprising
a display device for displaying an image.

9. A video image processing method comprising:
inputting a frame comprising a first left eye image and a first right eye image; and
allowing a display device to display a second left eye image that includes the inputted first left eye image but excludes at least part of an image located around the first left eye image, and a second right eye image that includes the inputted first right eye image but excludes at least part of an image located around the first right eye image, the second left eye image and the second right eye image being displayed with a resolution corresponding to a screen resolution of the display device.
